(19) United States
(12) Patent Application Publication
(10) Pub. No.: US 2019/0121054 A1
(43) Pub. Date: Apr. 25, 2019

(54) LENS BARREL AND OPTICAL DEVICE HAVING THE LENS BARREL

(71) Applicant: CANON KABUSHIKI KAISHA, Tokyo (JP)

(72) Inventor: Daisuke Shiraishi, Utsunomiya-shi (JP)

(21) Appl. No.: 16/166,698

(22) Filed: Oct. 22, 2018

(30) Foreign Application Priority Data
Oct. 25, 2017 (JP) 2017-206039

(51) Int. Cl. G02B 7/10; G02B 7/02

(52) U.S. Cl. CPC G02B 7/10; G02B 7/021

(57) ABSTRACT

The lens barrel comprising an optical system held by a holding portion, a fixed barrel, an operation ring rotatably supported in a circumferential direction with respect to the fixed barrel, a drive barrel that engages with the holding portion and rotate around the optical axis of the optical system to drive the holding portion in the optical axis direction, a transmitter to transmit to the drive barrel a rotational force of a motor or a rotational force of the operating ring, and a regulator to regulate the rotation of the transmitter so as to set a first range in which the transmitter rotates in the circumferential direction by the rotational force of the operating ring narrower than a third range which is wider than a second range in which the transmitter rotates in the circumferential direction rotated by the rotational force of the motor.

### BACKGROUND OF THE INVENTION

### Field of the Invention

The present invention relates to a lens barrel and an optical device having the lens barrel.

### Description of the Related Art

There is a zoom lens barrel that can be used by switching between manual zoom and electric zoom. A zoom lens drive device disclosed in Japanese Patent Application Laid-Open No. 63-303311 switches between a motor drive that automatically drives a zoom lens by transmitting a rotation of the zoom motor to a cam ring and a manual drive that manually drives the zoom lens without accepting the transmission of the rotation of the zoom motor to the cam ring.

However, in the zoom lens drive device disclosed in Japanese Patent Application Laid-Open No. 63-303311, since a range in which the zoom lens can be manually driven is wider than a range in which the zoom lens can be motor-driven, the field angle that can be shot is different between the manual drive and the motor drive.

### SUMMARY OF THE INVENTION

The present invention provides a lens barrel that can perform shooting with the same angle of view both in manual zoom and electric zoom.

The present invention comprises an optical system; a holding portion configured to holds the optical system; a fixed barrel; an operation ring configured to be supported rotatably in a circumferential direction with respect to the fixed barrel; a drive barrel that engages with the holding portion and rotate around an optical axis of the optical system to drive the holding portion in an optical axis direction; a transmitter configured to be rotatable in the circumferential direction and transmit a rotational force of a motor or a rotational force of the operating ring to the drive barrel; and a regulator configured to regulate the rotation of the transmitter so as to set a first range in which the transmitter can be rotated by the rotational force of the operating ring in the circumferential direction if the transmitter transmits the rotational force of the operation ring to the drive barrel narrower than a third range which is wider than a second range in which the transmitter can be rotated by the rotational force of the motor in the circumferential direction if the transmitter transmits the rotational force of the motor to the drive barrel.

Further features of the present invention will be described from the following description of the example description with reference to the attached drawings.

### BRIEF DESCRIPTION OF THE DRAWINGS

FIG. 1 is a block diagram illustrating a configuration of a camera system including a lens barrel according to the first embodiment.

FIG. 2 is a cross-sectional view of the lens barrel according to the first embodiment.

FIG. 3 is a side view of the lens barrel showing a fixed barrel and a rotation positioning member according to the first embodiment.

FIG. 4 is a cross-sectional view of the lens barrel according to the second embodiment.

FIG. 5 is an enlarged view of a portion A in FIG. 4.

FIG. 6 is a side view of the lens barrel showing the fixed barrel, a cam barrel, and a zoom key.

### DESCRIPTION OF THE EMBODIMENTS

### First Embodiment

Hereinafter, an embodiment for carrying out the present invention will be described with reference to drawings and the like. In each drawing, the same reference numerals are provided for parts and elements that are the same, and redundant description will be omitted.

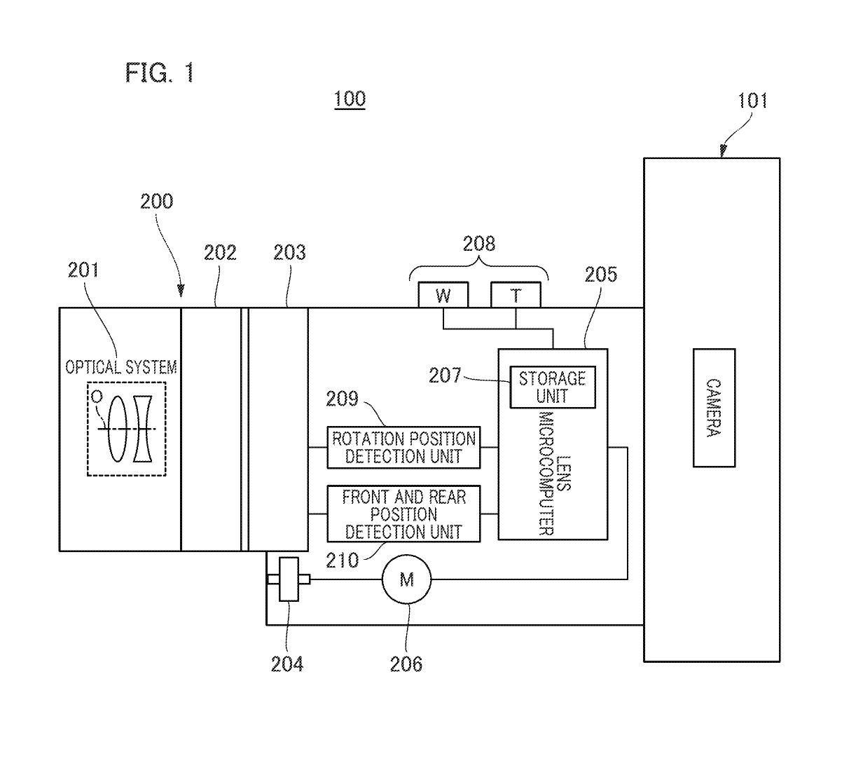

FIG. 1 illustrates a configuration of a camera system 100 including a lens barrel as an optical device. The camera system 100 includes a camera body 101 and a lens barrel 200. The lens barrel 200 is detachably attached to the camera body 101.

A configuration of the lens barrel 200 will be described. The lens barrel 200 includes an optical system 201, an operation ring 202, a coupling ring 203, a drive gear 204, and a lens microcomputer 205. The optical system 201 includes a plurality of lenses. A light emitted from an object (not illustrated) and incident to the optical system 201 provided in the lens barrel 200 is imaged by the optical system 201 to form an object image.

The operation ring 202 is a manual drive unit that is rotated by a user during zoom operation. The coupling ring 203 is a rotational force transmitter for transmitting a rotational force of the operating ring 202 to a cam barrel, which will be described below, during manual zoom operation. The drive gear 204 is provided on a rotation shaft of a motor 206, and the drive gear 204 rotates if the motor 206 is driven. The drive gear 204 and the motor 206 are electric drive units.

The lens microcomputer 205 is a control unit that controls, for example, a focus motor (not illustrated), a diaphragm mechanism (not illustrated), the motor 206 and so on, which are elements in the lens barrel 200. The lens microcomputer 205 includes a storage unit 207. The storage unit 207 stores the absolute rotation position of the coupling ring 203 at the optical wide-angle end and telephoto end of the lens barrel 200. The lens microcomputer 205 receives signals converted by the zoom switch 208, a rotation position detection unit 209, and a front and rear position detection unit 210.

The zoom switch 208 is a switch that outputs a zoom control signal by the photographer's operation. The zoom control signal output by the zoom switch 208 is converted into a digital signal and then input to the lens microcomputer 205. The lens microcomputer 205 controls the driving of the motor 206 in accordance with the zoom control signal that has been input.

The rotation position detecting unit 209 detects the absolute rotation position signal of the coupling ring 203. The rotation absolute position signal detected by the rotation position detection unit 209 is converted into a digital signal and then input to the lens microcomputer 205. The front and rear position detection unit 210 detects a front and rear position signal of the coupling ring 203 in the optical axis O direction. The front and rear position signal detected by the front and rear position detection unit 210 is converted into a digital signal and then input to the lens microcomputer 205.

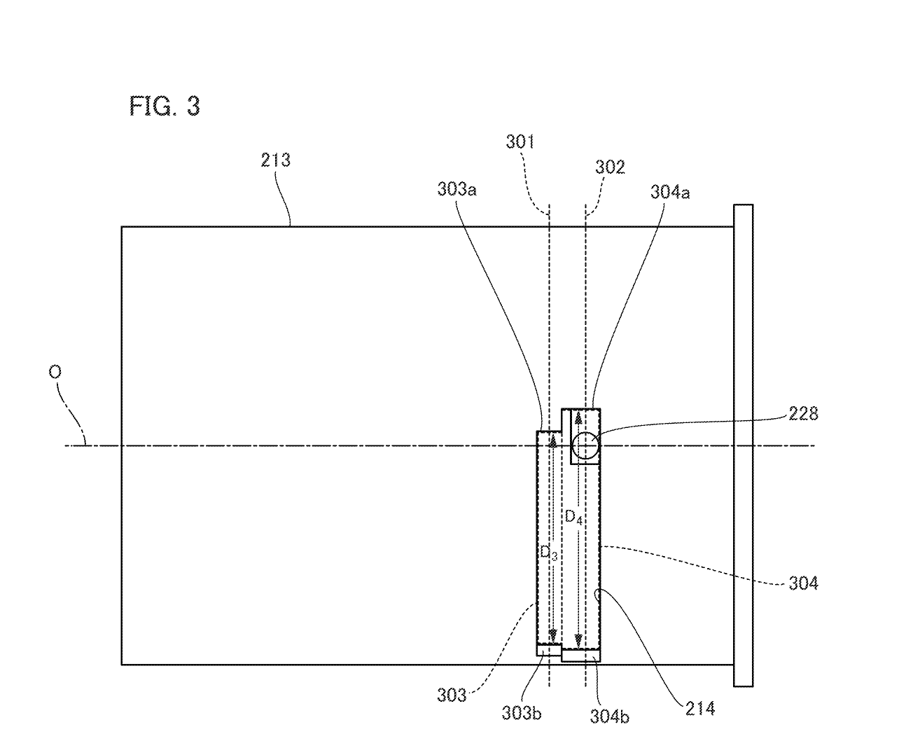

Specifically, the front and rear position detection unit 210 is configured to set the front and rear position signal HIGH if the coupling ring 203 is in a position during use of electric zooming, which is zoom position 302 in FIG. 3 and so-called electric driving or electric mode. Additionally, the front and rear position detection unit 210 is configured to set the front and rear position signal LOW if the coupling ring 203 is in a position during use of manual zooming, which is manual position 301 in FIG. 3 and so-called manual drive or manual mode. If the front and rear position signal is LOW, the lens microcomputer 205 prohibits the driving of the motor 206. Accordingly, during manual zoom operation, the motor 206 and the drive gear 204 are prohibited from idling.

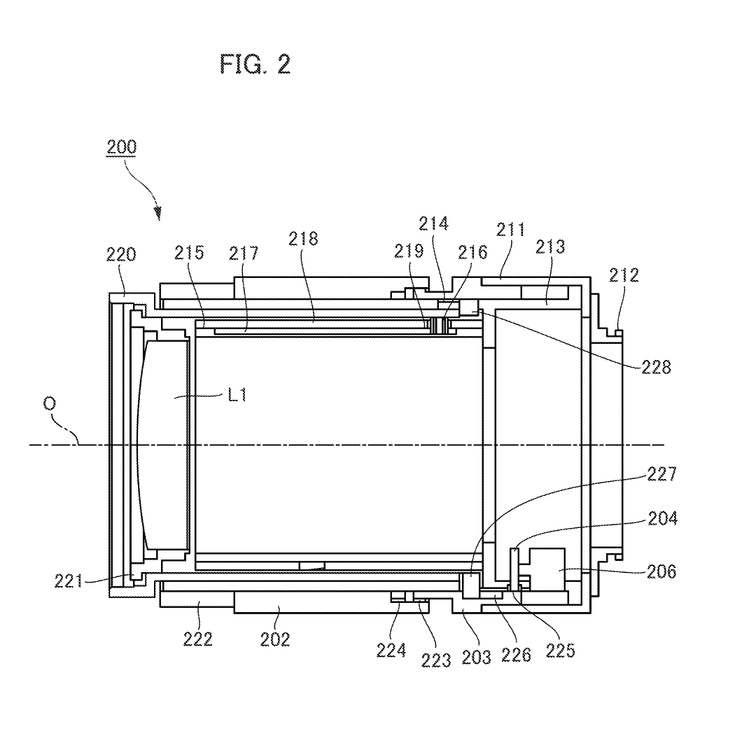

FIG. 2 is a cross-sectional view of the lens barrel according to the first embodiment. In FIG. 2, the left side in the drawing shows the object side and the right side shows the imaging plane side. An exterior barrel 211 is a cover member of a built-in member of the lens barrel 200, and is interposed and fixed between a lens mount 212 and a fixed barrel 213. The lens mount 212 includes a bayonet portion for mounting on the camera body 101, and is screwed and fixed to the fixed barrel 213. The fixed barrel 213 includes an opening 214 for restricting a rotation angle of the coupling ring 203. The opening 214 includes a first opening and a second opening that are long in the circumferential direction. The first opening and the second opening are connected side by side in the optical axis direction. The details of the opening 214 will be described below.

A rectilinear guide barrel 215 is screwed and fixed to the fixed barrel 213. A rectilinear groove 217 that extends in the direction of the optical axis O for linearly guiding a cam follower 216 is formed on the rectilinear guide barrel 215. A cam barrel 218 (drive barrel) is bayonet-coupled to the rectilinear guide barrel 215.

The cam barrel 218 is rotatable with respect to the rectilinear guide barrel 215 and movement in the direction of the optical axis O is restricted. The cam barrel 218 is formed with a cam groove 219 to which the cam follower 216 is engaged. If the cam barrel 218 is rotated, a linearly moving barrel 220 can be moved in the optical axis direction via the cam follower 216, in accordance with the movement of the intersection point of the rectilinear groove 217 extending in the direction of the optical axis O provided in the rectilinear guide barrel 215 and the cam groove 219 provided in the cam barrel 218.

A holding frame 221 that holds the first lens group L1 serving as an optical element is fixed to the linearly moving barrel 220. That is, the linearly moving barrel 220 is a holding unit that holds the optical system. Additionally, the cam follower 216 is fixed to the linearly moving barrel 220. Accordingly, it is possible to advance and retract the lens L1 in the optical axis O direction by rotating the cam barrel 218. Note that, in the lens barrel 200, in addition, a plurality of lens groups (not illustrated) are moved in the direction of the optical axis O with a similar mechanism to realize a shooting optical system, but the description will be omitted for simplicity of the description.

A focus ring 222 is held in a state in which it is rotatable with respect to the fixed barrel 213 and movement in the direction of the optical axis O is restricted. The focus ring 222 is an operation member for performing a manual focus adjustment operation. If the photographer manually rotates the focus ring 222 around the optical axis O, a focus lens group (not illustrated) moves in the direction of the optical axis O, and focus can be adjusted.

The operation ring 202 is supported rotatably around the fixed barrel 213. The operation ring 202 has an operation ring engagement portion 224 that engages with a manual zoom engagement portion 223 of the coupling ring 203 to be described below.

As described above, the drive gear 204 is provided on the rotation shaft of the motor 206, and so the drive gear 204 rotates if the motor 206 is driven. Note that the drive gear 204 may not be provided directly on the rotating shaft of the motor 206 but it may be installed via a plurality of gears.

The coupling ring 203 is rotatably supported to the fixed barrel 213. The coupling ring 203 functions as a transmitter that transmits a rotational force of the operating ring 202 to the cam barrel 218 during manual zooming. Additionally, the coupling ring 203 is also a rotational force transmitter for transmitting the rotational force of the drive gear 204 to the cam barrel 218 during electric zooming.

The coupling ring 203 can be slid in the direction of the optical axis O, in which the modes are switched by sliding the coupling ring 203 in the direction toward the object (left side in FIG. 2) when using manual zooming and by sliding the coupling ring 203 in the direction toward the imaging plane (right side in FIG. 2) when using electric zooming. FIG. 2 shows the coupling ring 203 is at the position of electric zooming.

A manual zoom engaging portion 223 is provided on the coupling ring 203, and during use of manual zoom, in other words, when the coupling ring 203 is slid to the object side, the manual zoom engaging portion 223 engages with the operating ring engaging portion 224 and the rotational force of the operation ring 202 is transmitted to the coupling ring 203. Additionally, the coupling ring 203 is provided with an electric zoom engagement portion 225, in which a gear tooth shape is formed. During use of electric zoom, in other words, when the coupling ring 203 is slid to the imaging plane side, the electric zoom engagement portion 225 engages with the drive gear 204, and the rotational force of the drive gear is transmitted to the coupling ring 203.

During use of manual zooming, the electric zoom engagement portion 225 and the drive gear 204 disengage from each other, and during use of electric zooming, the manual zoom engagement portion 223 and the operation ring engagement portion 224 disengage from each other. In the lens barrel 200 according to the present embodiment, the coupling ring 203 is slid in the direction of the optical axis O, the coupling ring 203 moves between the two positions in the optical axis direction, and as a result, switching between electric zoom and manual zoom is enabled.

A coupling ring rectilinear groove 226 is provided in the coupling ring 203, in which a zoom key 227, which is provided in the cam barrel 218, is fitted. Accordingly, if the coupling ring 203 rotates, its rotational force is transmitted to the cam barrel 218 via the zoom key 227, and the cam barrel 218 rotates. As described above, by rotating the cam barrel 218, the lens group including the lens L1 is moved in the optical axis O direction.

Specifically, during manual zooming, if the operator rotates the operating ring 202, the rotational force is transmitted to the coupling ring 203 and is further transmitted from the coupling ring 203 to the cam barrel 218. Additionally, during electric zooming, if the operator operates the zoom switch 208, the motor 206 rotates, and the rotational force of the motor 206 is transmitted to the drive gear 204. The rotational force of the drive gear 204 is transmitted to the coupling ring 203 and is transmitted from the coupling ring 203 to the cam barrel 218. Consequently, manual zooming operation and electric zooming operation are enabled.

The coupling ring 203 is provided with a rotation positioning member 228. The rotation positioning member 228 determines the circumferential position of the coupling ring 203. The rotation positioning member 228 is inserted into the opening 214 of the fixed barrel 213. FIG. 3 is a side view of the lens barrel showing the fixed barrel 213 and the rotation positioning member 228 according to the first embodiment. With reference to FIG. 3, a description will be given of a unit that restricts the rotation angle of the coupling ring 203 during manual zooming and electric zooming.

The opening 214 and the rotation positioning member 228 are restricting units that restrict the rotation angle of the coupling ring 203. The opening 214 and the rotation positioning member 228 restrict the rotation of the transmitter so as to set a range in which the coupling ring 203 is rotatable in the circumferential direction during manual zooming (first range) narrower than a range of the second opening 304 (third range) which is broader than a range in which the coupling ring 203 is rotatable in the circumferential direction during electric zooming (second range).

During manual zooming, the rotation positioning member 228 is in the manual zoom position 301 in the direction of the optical axis O, and moves inside a first opening 303. The rotation positioning member 228 comes into contact with wall surfaces 303a and 303b, which are the manual zoom position restricting portions of the first opening 303, and accordingly, the rotation position of the rotation positioning member 228 is restricted. Consequently, the rotation angle of the coupling ring 203 is restricted.

The position where the rotation positioning member 228 comes into contact with the wall surface 303a is the optical wide angle end of the lens barrel 200, and the position where the rotation positioning member 228 comes into contact with the wall surface 303b is the optical telephoto end of the lens barrel 200.

In contrast, during electric zooming, the rotation positioning member 228 is in the electric zoom position 302 in the direction of the optical axis O and moves inside a second opening 304. In the manufacturing process, the storage unit 207 stores the value of the absolute rotation position signal, which electrically indicates wide angle end of the coupling ring 203, detected at the time the rotation positioning member 228 arrives at maximum rotation angle position to comes into contact with the wall surface 304a, which regulates optical wide angle end, during electric zooming. Additionally, in the manufacturing process, the storage unit 207 stores the value of the absolute rotation position signal, which electrically indicates telephoto end of the coupling ring 203, detected at the time the rotation positioning member 228 arrives at minimum rotation angle position to comes into contact with the wall surface 304b, which regulates optical telephoto end, during electric zooming. During use of electric zoom, the lens microcomputer 205 controls the motor 206 so as to perform zoom drive in the range (second rage) between the electric wide-angle end and the electric telephoto end by using electric control. Specifically, the rotation positioning member 228 moves between each position of the second opening 304 corresponding to both of the end positions of the first opening 303.

As described above, a movable distance of the rotation positioning member 228 during manual zoom and during electric zoom becomes substantially equal. Specifically, if the movable distance of the rotation positioning member 228 during manual zoom is denoted by “D₁” and the movable distance of the rotation positioning member 228 during electric zoom is denoted by “D₂”, 0.8≤D₁/D₂≤1.2 is established. More preferably, 0.9≤D₁/D₂≤1.1 is established. As a result, both during manual zoom and during electric zoom, shooting with the same field angle can be performed.

Additionally, if comparing the distance D₃ that is from the wall surface 303a to the wall surface 303b of the first opening 303 and the distance D₄ that is from a wall surface 304a to a wall surface 304b of the second opening 304, the distance D₄ is longer. Specifically, D₃/D₄<1 is established. More preferably, D₃/D₄≤0.8 is established.

That is, if the rotation positioning member 228 is in the electric zoom position, the rotation positioning member 228 does not come into contact with the wall surfaces 304a and 304b even if it is rotated to the wide angle end position or the telephoto end position, which is the same as during manual zoom. Accordingly, it is possible to eliminate the collision sound caused by the rotation positioning member 228 coming into contact with the wall surfaces 304a and 304b during electric zoom.

### Second Embodiment

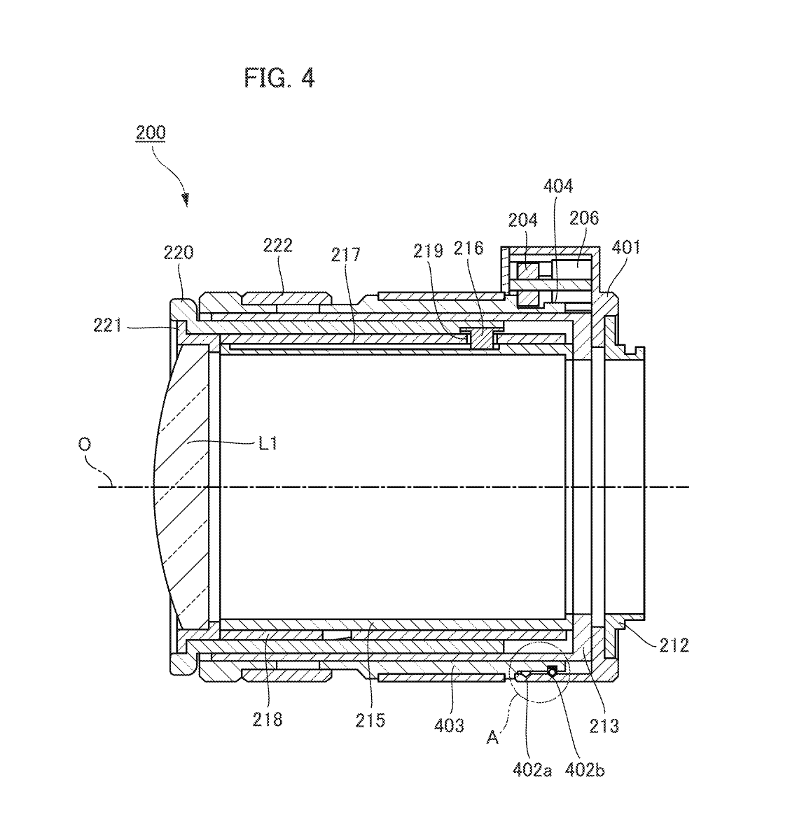

FIG. 4 is a sectional view including the optical axis of the lens barrel according to the second embodiment. An outer ring 401 according to the present embodiment covers an operation ring 403 from the outside and has two V grooves 402a and 402b (first grooves) extending in the circumferential direction on the inner periphery. Additionally, the restricting units according to the present embodiment are the opening 214 and the zoom key 227. The zoom key 227 corresponds to the rotation positioning member of the first embodiment.

The operation ring 403 is a manual drive unit that is rotated by the user during zooming operation. The operation ring 403 is supported so as to be rotatable with respect to the fixed barrel 213 and slidable by a predetermined amount in the optical axis O direction. The operation ring 403 has a zoom operation ring gear portion 404 that engages with the drive gear 204.

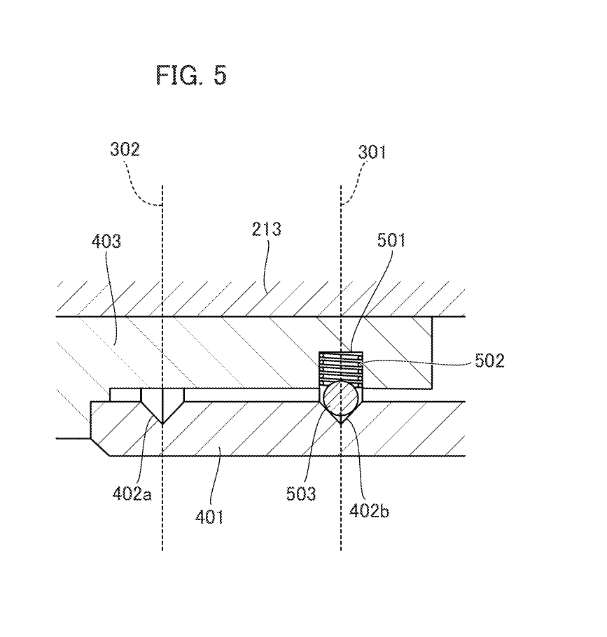

FIG. 5 illustrates an enlarged view of the portion A in FIG. 4. A concave part 501 having a substantially cylindrical shape (second groove) is formed on the outer periphery of the operation ring 403. In the concave part 501, a spring 502 and a ball 503 are arranged. The ball 503 fits into two V grooves 402a and 402b provided in the exterior barrel 211 and extends in the circumferential direction, and is biased toward the V grooves 402a and 402b by the spring 502. That is, the spring 502 is an urging unit.

The operating ring 403 is movable in the optical axis O direction between two positions in which the ball 503 fits. The operation ring 403 is rotatable with respect to the fixed barrel 213 at the position of the V groove 402a during use of electric zoom and at the position of the V groove 402b during use of manual zoom.

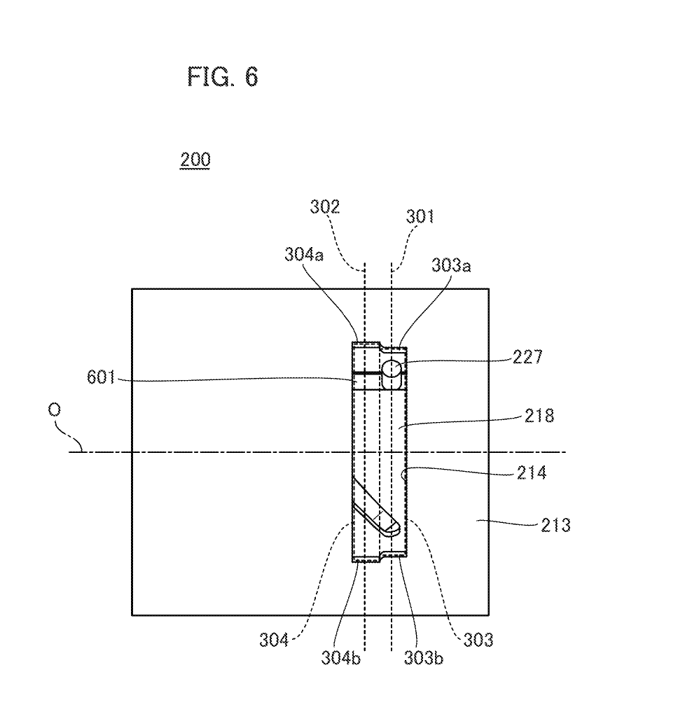

FIG. 6 is a side view of the lens barrel 200 showing the fixed barrel 213, the cam barrel 218, and the zoom key 227. The zoom key 227, which serves as a rotational force transmission unit, is screwed (not illustrated) and fixed to the operation ring 403. The zoom key 227 is fitted into the zoom key slide groove 601 provided in the cam barrel 218 in the short direction.

Therefore, if the operation ring 403 is rotated, the zoom key 227 transmits the rotational force of the operation ring 403 to the cam barrel 218, and as described in the first embodiment, the cam barrel 218 is rotated, thereby enabling a zoom operation. Additionally, the zoom key 227 is movable in the longitudinal direction of the zoom key slide groove 601. The zoom key 227 moves to each of the electric zooming position 302 and the manual zooming position 301 in conjunction with the movement of the operation ring 403 between the V groove 402a and the V groove 402b of the exterior barrel 211.

The zoom key 227 penetrates the opening 214 of the fixed barrel 213 and is fitted in the zoom key slide groove 601. The opening 214 of the fixed barrel 213 and the zoom key 227 are restricting units. During manual zooming, the zoom key 227 is in the manual zoom position 301 and moves in the first opening 303. The rotation position of the zoom key 227 is restricted by coming into contact with the wall surfaces 303a and 303b, which are the manual zoom position restricting units of the first opening 303.

During manual zooming, the position where the zoom key 227 comes into contact with the wall surface 303a is the optical wide-angle end of the lens barrel 200, and the position where the zoom key 227 comes into contact with the wall surface 303b is the optical telephoto end. In contrast, during electric zooming, the zoom key 227 is in the electric zoom position 302 and moves in the second opening 304. As shown in FIG. 6, the distance from the wall surface 304a to the wall surface 304b, which serves as the electric zoom position restricting unit of the second opening 304, is longer than the distance from the wall surface 303a to the wall surface 303b.

Specifically, if the zoom key 227 is in the electric zoom position 302 in the direction of the optical axis O, the zoom key 227 does not come into contact with the wall surfaces 304a and 304b even if it is rotated to the wide angle end position or the telephoto end position, which is the same as during manual zooming.

As described above, in a manner similar to the first embodiment, during manual zoom operation, the zoom key 227 is used by coming into contact with the wall surface 303a (optical wide-angle end) and the wall surface 303b (optical telephoto end) of the first opening 303 of the fixed barrel 213. Accordingly, it is possible to use the lens barrel with the conventional field angle. During electric zoom operation, the zoom key 227 is slid back and forth, and the zoom drive is performed in the range of the electric wide-angle end and the electric telephoto end that are equivalent to the optical wide-angle end and the optical telephoto end.

Therefore, the same angle of view is obtained both in manual zooming and electric zooming. Additionally, since, during electric zooming, the zoom key 227 does not come into contact with the wall surfaces 304a and 304b of the second opening 304 of the fixed barrel 213, the occurrence of a collision sound and image blur can be suppressed. Additionally, in the manual zoom position and the electric zoom position, the operation ring 403 can be securely fixed.

Note that, in the present embodiment, although the V grooves 402a and 402b are provided on the inner periphery of the exterior barrel 211 and the concave part 501 is provided on the outer periphery of the operation ring 403, this is an example. For example, the V grooves 402a and 402b may be provided on one of the outer periphery of the operation ring 403 and the inner periphery of the exterior barrel 211, and the concave part 501 may be provided in the other one.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-206039, filed Oct. 25, 2017, which is hereby incorporated by reference wherein in its entirety.

What is claimed is:

1. A lens barrel comprising:
an optical system;
a holding portion configured to hold the optical system;
a fixed barrel;
an operation ring configured to be supported rotatably in a circumferential direction with respect to the fixed barrel;
a drive barrel configured to engage with the holding portion and rotate around an optical axis of the optical system to drive the holding portion in an optical axis direction;
a transmitter configured to be rotatable in the circumferential direction and transmit a rotational force of a motor or a rotational force of the operating ring to the drive barrel; and
a regulator configured to regulate the rotation of the transmitter so as to set a first range in which the transmitter can be rotated by the rotational force of the operating ring in the circumferential direction if the transmitter transmits the rotational force of the operation ring to the drive barrel narrower than a third range which is wider than a second range in which the transmitter can be rotated by the rotational force of the motor in the circumferential direction if the transmitter transmits the rotational force of the motor to the drive barrel.

2. The lens barrel according to claim 1, wherein:
the regulator comprises;
a rotation positioning member that determines the position of the transmitter in the circumferential direction, and
a first opening provided in the fixed barrel and elongated in the circumferential direction, and
the first range is a movable range in the first opening of the rotation positioning member fitted in the first opening.

3. The lens barrel according to claim 2, wherein:
the regulator has a second opening that is elongated in the circumferential direction, and
the second range is a movable range in the second opening of the rotation positioning member fitted in the second opening.

4. The lens barrel according to claim 3 wherein the third range is a range equal to a wide of the second opening in an orthogonal direction of the optical axis direction

5. The lens barrel according to claim 3, wherein:
the first opening and the second opening are openings connected side by side in the optical axis direction, and
the rotation positioning member moves between each position of the second openings corresponding to both end positions of the first opening.

6. The lens barrel according to claim 1, wherein the transmitter moves between two positions in the direction of the optical axis to switch between transmitting the rotational force of the motor to the drive barrel or transmitting the rotational force of the operation ring to the drive barrel.

7. The lens barrel according to claim 1, wherein the transmitter moves between two positions in the optical axis direction to switch between an electric mode that electrically drives the drive barrel and a manual mode that manually drives the drive barrel.

8. The lens barrel according to claim 1, comprising an outer ring that covers the operation ring from the outside, wherein:
a first groove is provided on one of the outer periphery of the operation ring and the inner periphery of the outer ring, and a second groove is provided on the other one,
a ball is arranged in one of the first groove and the second groove, and a biasing member that biases the ball toward the one of the grooves is disposed on the other one of the grooves, and
the first groove and the second groove are respectively provided at two positions in the optical axis direction.

9. An optical device comprising:
a camera body configured to hold an imaging element; and
a lens barrel configured to guide a light from an object to the imaging element;
wherein the lens barrel comprises;
an optical system,
a holding portion configured to hold an optical system,
a fixed barrel,
an operation ring configured to be supported rotatably in a circumferential direction with respect to the fixed barrel,
a drive barrel configured to engage with the holding portion and rotate around an optical axis of the optical system to drive the holding portion in an optical axis direction,
a transmitter configured to be rotatable in the circumferential direction and transmit a rotational force of a motor or a rotational force of the operating ring to the drive barrel, and
a regulator configured to regulate the rotation of the transmitter so as to set a first range in which the transmitter can be rotated by the rotational force of the operating ring in the circumferential direction if the transmitter transmits the rotational force of the operation ring to the drive barrel narrower than a third range which is wider than a second range in which the transmitter can be rotated by the rotational force of the motor in the circumferential direction if the transmitter transmits the rotational force of the motor to the drive barrel.
